(19) United States
(12) Patent Application Publication
(10) Pub. No.: US 2026/0233773 A1
(43) Pub. Date: Aug. 13, 2026

(54) HORIZONTALLY STACKABLE SHOPPING TROLLEY

(71) Applicants: Riccardo BIZZARRI, Foligno, Perugia (IT); Marco BIZZARRI, Foligno, Perugia (IT); Fabrizio BIZZARRI, Foligno, Perugia (IT); Mauro MORETTINI, Foligno Perugia (IT)

(72) Inventor: Marco BIZZARRI, Foligno, Perugia (IT)

(73) Assignees: Riccardo BIZZARRI, Foligno, Perugia (IT); Marco BIZZARRI, Foligno, Perugia (IT); Fabrizio BIZZARRI, Foligno, Perugia (IT); Mauro MORETTINI, Foligno, Perugia (IT)

(21) Appl. No.: 19/158,062

(22) PCT Filed: Jan. 29, 2024
(86) PCT No.: PCT/IB2024/050804

§ 371 Date: Aug. 20, 2025

(30) Foreign Application Priority Data
Feb. 20, 2023 (IT) 202023000000618

(51) Int. Cl. B62B 3/18; B62B 3/00

(52) U.S. Cl. CPC B62B 3/184; B62B 3/005

(57) ABSTRACT

A horizontally stackable shopping trolley (1) comprising: a plurality of wheels (2-6) for moving the trolley (1) and a basket (8) positioned above said plurality of wheels (2-6). The basket (8) is provided at the top with an upper opening (8′) for the introduction of at least one product and comprises a bottom (9), at least one containment wall (10) rising from the bottom (9) and a first and a second door (11a, 11b) positioned at the rear side of the basket (8). The first door (11a) and the second door (11b) are rotatable respectively around a first and a second rotation axis (R′, R″), substantially vertical or slightly inclined with respect to the relative vertical, between a respective closing position, in which together they close the rear side of the basket (8), and a respective completely open position, in which they leave the rear side of the basket (8) free or substantially free to allow the insertion of the basket (8) of a further trolley (1) according to a horizontal direction.

This invention relates to a horizontally stackable shopping trolley.

For the purposes of this invention, the expression “horizontally stackable shopping trolley” means a shopping trolley that can be grouped with one or more trolleys identical to it in such a way as to form a horizontal row with the latter.

This grouping also implies that each trolley partially penetrates, in a reversible manner, the one that precedes it in the row, that is to say, the one positioned in front of it.

There are prior art pushed shopping trolleys provided with a plurality of wheels in their lower part for their relative mobility and a trapezoidal basket positioned above these wheels and intended to contain one or more objects, that is to say, one or more products purchased during the shopping.

Usually, the basket of traditional pushed shopping trolleys has a rear side that can be tilted vertically around a horizontal axis of rotation positioned at the top of the same rear side of the basket.

This technical measure makes it possible to stack horizontally, that is to say, to arrange like a horizontal row, a plurality of trolleys of the type indicated above.

In more detail, the horizontal stacking can be achieved by inserting the front of each trolley into the rear of the one preceding it, thus rotating upwards the tilting rear side of the basket of the latter.

In this way, a horizontal row of trolleys is obtained in which each trolley partially penetrates the one that precedes it.

However, this type of traditional shopping trolley has several disadvantages and technical limitations.

Firstly, it is noted that the basket of these trolleys must necessarily have a length greater than the rear height, that is, the height of the tilting rear side, to allow the relative tilting upwards.

In addition, the upper edge of the basket must necessarily be lower than the rotation axis of the rear door, that is, the tiltable rear side of the basket itself.

In addition to this, due to the trapezoidal shape of the basket, the vertically tiltable rear door must also have a trapezoidal shape tapered downwards to be able to rotate upwards until it adopts a substantially horizontal position and thus allow the insertion of a further trolley; this means that when the rear door is lowered, that is, in a vertical closing position, two empty spaces of considerable size are formed between the latter and the side walls of the basket that could in some cases also result in the escape of small products from the basket.

Moreover, for the purposes of the horizontal stacking, it is necessary to exert on each trolley a thrust force of a certain intensity to lift the rear door of the trolley that precedes it in the row.

The aim of the present invention is to overcome the problems of the prior art described above.

Another object of the invention proposed herein is to provide a horizontally stackable shopping trolley which can have a basket with more compact horizontal dimensions (that is, length and width).

A further aim of the invention is to provide a horizontally stackable shopping trolley with a basket having a length less than its height.

Another aim of the present invention is to provide a horizontally stackable shopping trolley which is also easily usable in small areas or passageways, such as those of small supermarkets or convenience stores.

A further aim of the present invention is to provide a horizontally stackable shopping trolley which is particularly easy to use, that is, easily maneuverable.

Another aim of the invention is to provide a horizontally stackable shopping trolley which is easy to manage in the relative rotational maneuverer.

A further aim of the present invention is to provide a horizontally stackable shopping trolley which has a basket with an adequate load capacity, albeit with small horizontal dimensions.

Another aim of the invention is to provide a horizontally stackable shopping trolley which is reliable in use.

A further aim of the invention is to provide a horizontally stackable shopping trolley which is structured in such a way as not to present, in the relative configuration of use, cracks or empty spaces of such dimensions as to make it possible for articles or products to escape from the basket.

Another aim of the invention is to provide a horizontally stackable shopping trolley, which allows horizontal stacking to be performed easily by applying a reduced intensity of thrust force at each trolley insertion operation.

The specific object of the present invention is therefore a horizontally stackable shopping trolley comprising: a plurality of wheels for moving the trolley; and a basket positioned above said plurality of wheels to contain, in use, at least one product or article; said basket being provided at the top with an upper opening for the introduction of at least one product or article and comprising a bottom, at least one containment wall rising from the bottom and a first door and a second door positioned at the rear side of the basket; said first door and said second door being rotatable respectively around a first rotation axis and a second rotation axis, substantially vertical or slightly inclined with respect to the relative vertical, between a respective closing position, in which together they close the rear side of the basket, and a respective completely open position, in which they leave the rear side of the basket free or substantially free to allow the insertion of the basket of a further trolley according to a horizontal direction.

Preferably according to the invention, the first rotation axis and the second rotation axis are orthogonal to the bottom of the basket.

Advantageously according to the present invention, the first rotation axis and the second rotation axis can be slightly inclined backwards with respect to the respective vertical in such a way that the first door and the second door tend to adopt the respective closing position due to the force of gravity.

Conveniently according to the invention, the first door and the second door can be rotatably openable towards the inside of the basket with mutually opposite directions of rotation.

Preferably according to the invention, when the first door and the second door are in the respective position of complete opening, said first door and second door are positioned substantially adjacent to inner sides of the at least one containment wall.

Conveniently according to the invention, said trolley can comprise at least one lower abutment element for providing a contact to lower portions of said first door and second door in the relative closed positions.

Further, according to the invention, said trolley can comprise at least one upper abutment element for providing a contact to upper portions of said first door and second door in the relative closed positions.

Advantageously according to the invention, said trolley can comprise a handle, positioned above the basket, for maneuvering said trolley, and said at least one upper abutment element can extend downwards from said handle.

Preferably according to the invention, from a top zone of the at least one containment wall a recess extends downwards, at a front zone of said at least one containment wall, having dimensions such as to be traversable by the at least one upper abutment element of a further trolley when said trolley is grouped to said further trolley by means of a horizontal stacking operation.

Further, according to the invention, said trolley can comprise a lower support structure positioned between the plurality of wheels and the basket and provided, at the rear, with a rear cavity configured to receive the lower support structure of a further trolley when inserting, according to a horizontal direction, the basket of said further trolley into the basket of said trolley through the rear side of the latter basket.

Features and advantages will be further highlighted by the following description of a preferred but not exclusive embodiment illustrated, purely by way of example and not limiting, in the attached drawing, in which:

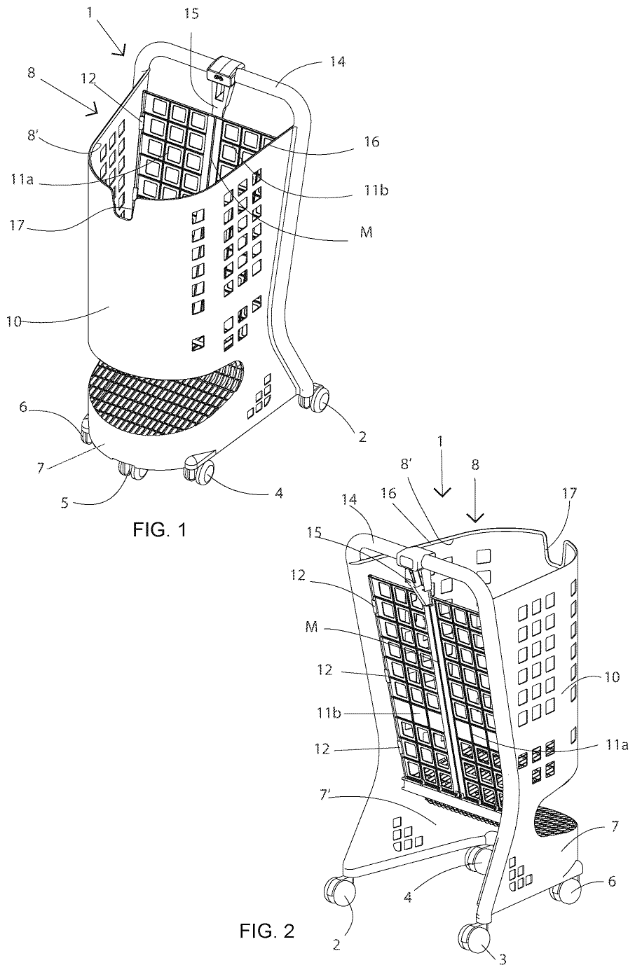

FIG. 1 is a first perspective view of a horizontally stackable shopping trolley according to the present invention, in the relative configuration of use, that is with the rear doors completely closed;

FIG. 2 is a second perspective view of the trolley shown in FIG. 1, in the same configuration of use;

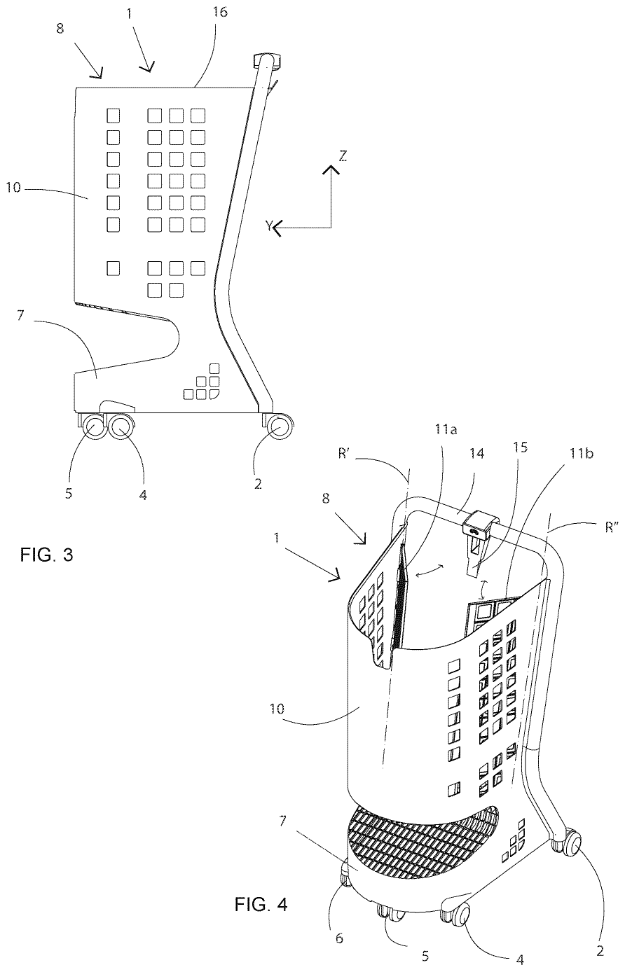

FIG. 3 is a side view of the trolley of FIGS. 1 and 2, again in the configuration of use;

FIG. 4 is a perspective view of the trolley shown in FIGS. 1-3, in an intermediate configuration, that is, with the rear doors partially open;

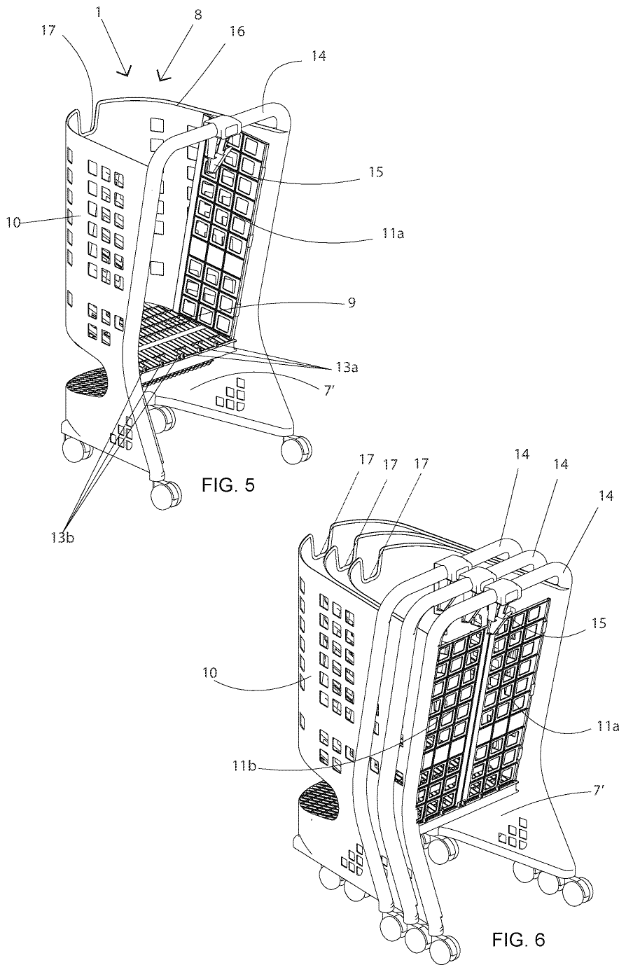

FIG. 5 is a perspective view of the trolley of FIGS. 1-4, in the horizontal stacking configuration, that is, with the relative rear doors fully open; and

FIG. 6 is a perspective view of three trolleys identical to that shown in FIGS. 1-5, stacked horizontally.

With reference to the accompanying drawings, a horizontally stackable shopping trolley according to the present invention has been denoted in its entirety with reference numeral 1.

This trolley 1 has, underneath, five wheels, namely two rear wheels 2, 3 and three front wheels 4, 5, 6 positioned at the vertices of an isosceles triangle, all rotatable around a respective horizontal axis of rotation and each adjustable on a horizontal plane according to a vertical axis of rotation.

According to a variant of the present invention, the two rear wheels 2, 3 can have a fixed orientation, that is, oriented according to a respective fixed vertical plane.

All the above-mentioned wheels 2, 3, 4, 5, 6 are mounted under a lower support structure 7 of the trolley 1, which is hollow at the rear, that is, provided with a rear cavity 7′ and having, in particular, a substantially C-shaped plan.

The same trolley 1 also comprises a basket 8 positioned above and connected to the lower support structure 7.

An upper opening 8′ is defined in the top area of the basket 8 to allow one or more products or items purchased during the shopping and/or other products or items to be placed inside the basket 8.

Specifically, the basket 8 is formed by a bottom 9 which is substantially horizontal or slightly oblique with respect to a horizontal plane, a shaped containment wall 10 that rises from the bottom 9 upwards in a substantially vertical manner occupying the front part and the two lateral parts of the trolley 1, and a first rear door 11a and a second rear door 11b respectively connected, by means of hinges 12, to rear areas of the shaped containment wall 10 in a rotatable manner, respectively, around a first axis of rotation R′ and a second axis of rotation R″ orthogonal to the bottom 9 and passing through at the connection areas to said shaped containment wall 10.

More in detail, the first rear door 11a and the second rear door 11b can each rotate around the relative axis of rotation R′, R″, towards the inside of the basket 8 between a respective closed position (see FIGS. 1 and 2) and a respective position of complete opening (see FIG. 5), and vice versa.

The first rear door 11a and the second rear door 11b are then enabled to rotate towards the inside of the basket 8 with mutually opposite directions of rotation.

When both are in the closed position, the first rear door 11a and the second rear door 11b together occupy the entire rear side of the basket 8 forming with the shaped containment wall 10 and the bottom 9 a container. open at the top.

When both are in the position of complete opening, the first rear door 11a and the second rear door 11b are positioned adjacent to the inner sides of the shaped containment wall 10 leaving the rear side of the basket 8 completely open.

The first rear door 11a and the second rear door 11b have the same rectangular shape with identical dimensions; this means that the (straight) separation line S between the two doors 11a, 11b in the closed position matches the centre line M of the rear side of the basket 8 (see FIG. 2).

The bottom 9, the side areas of the shaped containment wall 10 and the two rear doors 11a, 11b preferably have respective openings.

On the rear area of the bottom 9 there are a first plurality of lower abutment elements 13a and a second plurality of lower abutment elements 13b, both rising upwards by a few millimetres in such a way as to act as lower abutments (that is, stops), respectively for the first rear door 11a and for the second rear door 11b in their respective closed positions.

The trolley 1 is also provided with a horizontal handle 14 arranged above the basket 8 at the rear side thereof, to allow a person to manually push and maneuver the trolley 1.

From the central area of the horizontal handle 14 an upper abutment element 15 extends downwards, positioned in such a way as to act as an upper abutment (that is, stop) for both the first rear door 11a and the second rear door 11b, in their respective closed positions (see FIG. 2).

Preferably, the bottom 9 of the basket 8 is inclined or slightly inclined with respect to a horizontal plane in such a way that the front part of the bottom 9 is at a higher level with respect to the rear part of the bottom 9 itself; this means that the above-mentioned axes of rotation R′, R″—which, as mentioned above, are orthogonal to the bottom 9—are also inclined backwards with respect to the respective vertical, and therefore that the rear doors 11a, 11b tend to adopt, under the effect of gravity, their respective closed positions making contact with the first plurality of lower abutment elements 13a, the second plurality of lower abutment elements 13b and with the upper abutment element 15.

To allow the horizontal stacking of several trolleys 1, while maintaining the upper edge line 16 of the shaped containment wall 10 higher than the lower edge of the upper abutment element 15 for a greater load capacity of the basket 8, at the front of the shaped containment wall 10 there is a recess 17 extending downwards from the same upper edge line 16.

Specifically, the recess 17 has a shape such as to allow the passage through it by the upper abutment element 15 of another trolley 1 when performing an operation of horizontal stacking of several trolleys 1 (see FIG. 6).

Preferably, with the exception of the two rear doors 11a, 11b, the trolley 1 is made of a single piece of plastic material.

As shown in FIG. 6, for the horizontal stacking of several trolleys 1, it is sufficient to push each trolley 1—which is grouped with the others—towards the rear part of the last trolley 1 of the row, making sure that the front part of the shaped containment wall 10 of the trolley 1 pushed strikes the rear doors 11a, 11b of said last trolley 1, making them open completely and allowing the entry of the basket 8 of the trolley 1 pushed into the basket 8 of said last trolley 1 and also the entry of the lower support structure 7 of the trolley 1 pushed into the rear cavity 7′ of the same last trolley 1.

By carrying out the horizontal stacking in the manner set out above, a reduction in the overall longitudinal size of the trolleys 1 thus stacked is therefore obtained.

The thrust force necessary to insert each trolley 1 at the end of the row of trolleys 1 is, in this case, of modest magnitude in consideration of the fact that it will only have to overcome the resistance to rotation of two horizontally rotatable doors, that is, around substantially vertical axes of rotation, and not the resistance to rotation of a single door of substantial dimensions and rotatable around an upper horizontal axis of rotation.

The trolley according to the present invention also has the advantage of being able to have a basket of very compact dimensions and, more precisely, of being able to have a basket with a length (that is, dimension according to the Y axis) smaller than its height (that is, dimension according to the Z axis), offering in any case a satisfactory load capacity.

It is understood that the above has been described by way of example and not limiting, so that any variant embodiments are intended to fall within the scope of protective of this technical solution, as described above and claimed below.

1. Horizontally stackable shopping trolley (1), comprising:
a plurality of wheels (2, 3, 4, 5, 6) for moving the trolley (1); and
a basket (8) positioned above said plurality of wheels (2, 3, 4, 5, 6) to contain, in use, at least one product or article; said basket (8) being provided at the top with an upper opening (8′) for the introduction of at least one product or article and comprising a bottom (9), at least one containment wall (10) rising from the bottom (9) and a first door (11a) and a second door (11b) positioned at the rear side of the basket (8); said first door (11a) and said second door (11b) being rotatable respectively around a first rotation axis (R′) and a second rotation axis (R″), substantially vertical or slightly inclined with respect to the relative vertical, between a respective closing position, in which together they close the rear side of the basket (8), and a respective completely open position, in which they leave the rear side of the basket (8) free or substantially free to allow the insertion of the basket (8) of a further trolley (1) according to a horizontal direction.

2. Trolley (1) according to claim 1, wherein the first rotation axis (R′) and the second rotation axis (R″) are orthogonal to the bottom (9) of the basket (8).

3. Trolley (1) according to claim 1, wherein the first rotation axis (R′) and the second rotation axis (R″) are slightly inclined backwards with respect to the respective vertical in such a way that the first door (11a) and the second door (11b) tend to adopt the respective closing position due to the force of gravity.

4. Trolley (1) according to claim 1, wherein the first door (11a) and the second door (11b) are rotatably openable towards the inside of the basket (8) with mutually opposite directions of rotation.

5. Trolley (1) according to claim 1, wherein when the first door (11a) and the second door (11b) are in the respective position of complete opening, said first door (11a) and second door (11b) are positioned substantially adjacent to inner sides of the at least one containment wall (10).

6. Trolley (1) according to claim 1, wherein it comprises at least one lower abutment element (13a, 13b) for providing a contact to lower portions of said first door (11a) and second door (11b) in the relative closed positions.

7. Trolley (1) according to claim 1, wherein it comprises at least one upper abutment element (15) for providing a contact to upper portions of said first door (11a) and second door (11b) in the relative closed positions.

8. Trolley (1) according to claim 7, wherein it comprises a handle (14), positioned above the basket (8), for maneuvering said trolley (1), and in that said at least one upper abutment element (15) extends downwards from said handle (14).

9. Trolley (1) according to claim 7, wherein from a top zone of the at least one containment wall (10) a recess (17) extends downwards, at a front zone of said at least one containment wall (10), having dimensions such as to be traversable by the at least one upper abutment element (15) of a further trolley (1) when said trolley (1) is grouped to said further trolley (1) by means of a horizontal stacking operation.

10. Trolley (1) according to claim 1, wherein it comprises a lower support structure (7) positioned between the plurality of wheels (2, 3, 4, 5, 6) and the basket (8) and provided, at the rear, with a rear cavity (7′) configured to receive the lower support structure (7) of a further trolley (1) when inserting, according to a horizontal direction, the basket (8) of said further trolley (1) into the basket (8) of said trolley (1) through the rear side of the latter basket (8).
